(19) United States
(12) Patent Application Publication
(10) Pub. No.: US 2009/0305553 A1
(43) Pub. Date: Dec. 10, 2009

(54) Network Connection Device

(75) Inventors: David Thomas, Chester (GB); Albert Font Aranega, Badalona (ES); Hans-Juergen Niethammer, Kirchheimbolanden (DE)

Correspondence Address: BAKER & DANIELS LLP, 300 NORTH MERIDIAN STREET, SUITE 2700, INDIANAPOLIS, IN, 46204, US

(73) Assignee: Tyco Electronics UK Ltd, Wiltshire (GB)

(21) Appl. No.: 12/084,447

(22) PCT Filed: Nov. 3, 2006
(86) PCT No.: PCT/GB2006/004111

§ 371 Date: May 1, 2008

(30) Foreign Application Priority Data
Nov. 4, 2005 (GB) 0522543.8

(51) Int. Cl. H01R 13/74

(52) U.S. Cl. 439/540.1

(57) ABSTRACT

A patch panel comprises one or more support members supporting a plurality of cable terminations that are each operatively connectable to a respective data cable for the transmission of data. Each cable termination is operatively connected to a respective first socket that is open on a side of the patch panel such that a plug inserted into the first socket is connectable to a said data cable via a data transmission path forming part of the patch panel. The patch panel additionally includes in at least one of the data transmission paths a further connector that permits the connection in the first data transmission path of one or more additional components, such as a module providing status information or power over Ethernet capabilities.

This invention relates to a network connection device such as but not limited to a patch panel. This is usually a comparatively simple device used when preparing the data connections in a computer network such as a LAN (local area network).

At its simplest a patch panel is a generally flat, rectangular plate that is securable in a rack in e.g. a patch cabinet or at a node of a LAN, such that one, front side of the plate is oriented forwardly towards an opening in the cabinet, etc. and the opposite side defines a rear face. The rear face in use of the patch panel faces the interior of the cabinet or other housing in which the patch panel is installed.

Formed in the flat plate is a series of apertures each of which supports a socket assembly. The socket assemblies typically are of a well-known type, the most common of which at the present time is the “RJ-45” jack socket. The apertures of the sockets are arranged in rows such that they are accessible via the front side of the patch panel.

On the rear side of the patch panel there is a series of cable terminations corresponding in number to the number of socket assemblies supported in the patch panel. Each cable termination is in prior art patch panels connected directly to an associated one of the socket assemblies.

In use of the patch panel a plurality of data cables are respectively secured in data-transmitting fashion to the cable terminations. The data cables extend beyond the cabinet or other housing containing the patch panel, and define the data pathways of the LAN. Thus the cables connect the various nodes of the LAN, to which devices such as but not limited to personal computers may be operatively connected, and the patch panel sockets to one another to permit the transmission of data over the LAN.

The sockets of the patch panel are connected, by way of plugs that are removably inserted therein, to e.g. the output connectors of a LAN switching device which controls the flow of data around the LAN. The use of removably insertable plugs permits the re-configuration of the network as needed, for example as its complexity increases over time following the addition of extra nodes.

Typically a patch panel includes a label holder for holding a replaceable label made of paper or card. The label may provide a visual or readable summary of the connection for which each socket of the patch panel is employed. Some more sophisticated types of patch panel include lamps or light-emitting diodes (LED's) that illuminate to indicate when a particular socket is in use to transmit data.

Of rapidly growing interest at the present time is the provision of electrical power using Ethernet cabling such as that defining a LAN.

A typical “Category 5” data transmission cable (which is a type very commonly used in LAN cabling applications) consists of four twisted pairs of conductor wire. These are used to transmit data in the form of voltages whose maximum and minimum values are dictated by internationally agreed standards.

It is possible to use data cables of this kind for the provision of electrical power as well as data, without reducing the ability of the cables simultaneously to transmit data reliably and without crosstalk.

This is achieved primarily through the use of both active control elements and certain passive components (such as centre-tapped secondary windings of transformers forming part of the LAN) that permit the connection of power supplied to the data cables. The active and passive components limit the voltages transmitted via the cables so that they lie within the maximum and minimum values permitted under the aforesaid standards.

In some applications of this “power over Ethernet” (also sometimes referred to as “power over LAN”) technology the transmission of data and electrical power occurs simultaneously using the same pairs of the cables. In other applications there is a mix of uses such that some of the pairs are used for mixed data and power transmission and others are dedicated to the transmission of either power or data.

Various devices are capable of operating at the power levels provided using power over Ethernet technology. Such devices if connected to a node of the LAN may draw operating power from the network without any need for a separate connection to mains power. Such devices include internet protocol (IP) telephones, CCD cameras, sensors of alarm systems, card readers and similar apparatuses. There is even available a personal computer that operates at the power levels available from a power over Ethernet arrangement.

Also a power over Ethernet-enabled network may provide backup power to devices, such as conventional personal computers, at times when mains power is unavailable. In such applications the active devices controlling the distribution of power over the LAN in question can be arranged to send network messages to devices connected at its nodes, thereby initiating modes of operation that minimise power consumption.

The advantages of providing power over a LAN or Ethernet are such that interest in this technology is growing rapidly. However, many buildings and other locations where network cabling is installed do not incorporate the active and passive components needed to permit the transmission of power.

The structured (i.e. built-in) cabling of a new building is nowadays intended to remain in use for 10-20 years. Therefore in the majority of applications it would be uneconomical to replace it with cabling incorporating the parts needed to provide Power over Ethernet transmission.

As indicated, certain LAN components incorporate electronic components whose function typically is that of providing indications to a user that a particular socket is in use for data transmission, and similar functions. It is desirable to be able to upgrade the electronic components needed on a more frequent basis than the 10-20 year life of structured LAN cabling. This can derive, for example, from a need to provide additional functions to the simple ones known in the art.

Thus overall there is a need to provide LAN components that permit ready upgrading of the LAN to incorporate electronics modules and parts as desired.

This need is beneficially met in a network connection device according to the invention comprising one or more support members supporting a plurality of cable terminations that are each operatively connectable to a respective data cable for the transmission of data, each cable termination being operatively connected to a respective first socket that is open on a side of the network connection device such that a plug inserted into the first socket is connectable to a said data cable via a data transmission path forming part of the network connection device, the network connection device additionally including in at least a first said data transmission path a further connector that permits the connection in the first data transmission path of one or more additional components.

In a practical embodiment of the network connection device according to the invention the further connector is located such that additional components may easily be connected in the data transmission path from or adjacent the front side of the patch panel.

A network connection device according to the invention (in the form of eg. a patch panel) permits the insertion into a pre-existing LAN of any of a range of electronic modules such as (but not limited to) those permitting the LAN to transmit power. Examples of other modules that are connectable in a LAN incorporating a network connection device according to the invention include an indicator module including a display panel comprising one or more LED's or other display media. These may be configured as part of a circuit whose function is to provide a visual indication of the connection mode of each socket of the device. Such an arrangement may partly or even entirely obviate the need for the written or printed connection labels of the prior art.

Preferably a plurality of data transmission paths in the network connection device each include a said further connector. In practice, all the data transmission paths desirably would include such a further connector, whereby any part of a pre-existing LAN may benefit from the incorporation of additional or replacement electronic components as frequently as desired.

It is also preferable that one or more said data transmission paths each include a switch that is operatively connected to the associated further connector. Conveniently at least one said switch is, in the absence of a said additional component, closed such that there is a direct data transmission path between the associated said cable termination and first socket; and is open when a said additional component is connected in the data transmission path such that the transmission of data takes place via the additional component.

Thus the switch permits the network connection device to function in a conventional manner when no additional electronic component is connected; and to function in dependence on such a component when one is present.

In a preferred embodiment of the invention the or each further connector includes a second socket. It is also preferred that the or each further connector is located on an in-use rear side of the support member.

The foregoing features advantageously permit the incorporation of electronics components at two locations in each data transmission path, i.e. at each further socket on the rear of the network connection device, eg. patch panel, and also at each first socket on the in use front face of the panel. Such an arrangement is needed for example in some Power over Ethernet applications.

Preferably the network connection device includes one or more said additional components connected in one or more said data transmission paths. Such an arrangement makes practical use of the plurality of data transmission lines provided by a typical patch panel structure.

The or each additional component conveniently is selected from the list including:
a “power over Ethernet” component
an indicator device and/or a sub-band communication apparatus.

It is also preferable when that the or each additional component is a “power over Ethernet” component it includes one or more of:
a power management device
an inductance
a combiner
a filter.

An out of band communications apparatus has been developed that includes first and second data lines arranged in a differential pair. The data lines convey high speed data within a first frequency range and out of band data within a second frequency range that differs from the first frequency range. The apparatus also includes a band pass filter coupled to the first and second data lines. The filter only passes the out of band data and blocks the high speed data. The apparatus also includes a device coupled to said band pass filter and configured to at least one of transmit and receive out of band data.

Certain embodiments of such an arrangement may also include a transformer having a center power tap for one of adding and removing power from the first and second data lines. Alternatively, the filter may include a digital signal processor and an analog to digital converter configured to convert the out of band data to a digital signal.

Certain other variants on this arrangement may also include a filter configured to pass frequencies below 100 kilohertz. Optionally, the second frequency range of the apparatus may be between 100 hertz and 100 kilohertz. Alternatively, the second frequency range of the apparatus may be between 100 hertz and 20 kilohertz.

Such apparatuses may be incorporated into or may form the operational part of the apparatus of the invention. The scope of the invention therefore embraces all arrangements including sub-band communication apparatuses as described.

Furthermore the connection device may be or include one or more visual indicators (such as but not limited to LED's and other display devices). All such combinations lie within the scope of the invention.

When the or each additional component is an indicator device it preferably is capable of providing a visible, audible or other sensory indication of the statuses of the connections of the patch panel. Such a device may provide functionality over and above that of the prior art indicator lamps that are permanently connected as parts of the known RJ-45 sockets. This is not least because the insertion of a separate module into a data transmission line permits the use of more sophisticated electronics than has hitherto been possible in relation to patch panel indicator functions. Thus for example liquid crystal or other displays may be incorporated in order to provide intuitive, meaningful messages for users.

It is also possible within the scope of the invention, as indicated, to connect one or more additional components via one or more of the first sockets (which may be but are not limited to RJ-45 sockets) in order to enhance the functionality of the LAN. An example of the type of component that may be fitted in this manner is a LAN switch/repeater module that is modified to be suitable in Power over Ethernet applications.

Conveniently the or each support member includes secured thereto one or more support brackets that preferably are securable to racking in a patch cabinet or other housing.

In one preferred form of the invention the brackets are such as to permit recessing of the patch panel compared to the position it would otherwise occupy in such a cabinet in the absence of the brackets. This arrangement permits the patch panel to support the additional components even if they would otherwise protrude from the patch panel so as to cause fouling with a door or cover forming part of the cabinet.

There now follows a description of a preferred embodiment of the invention, by way of non-limiting example, with reference being made to the accompanying drawings in which:

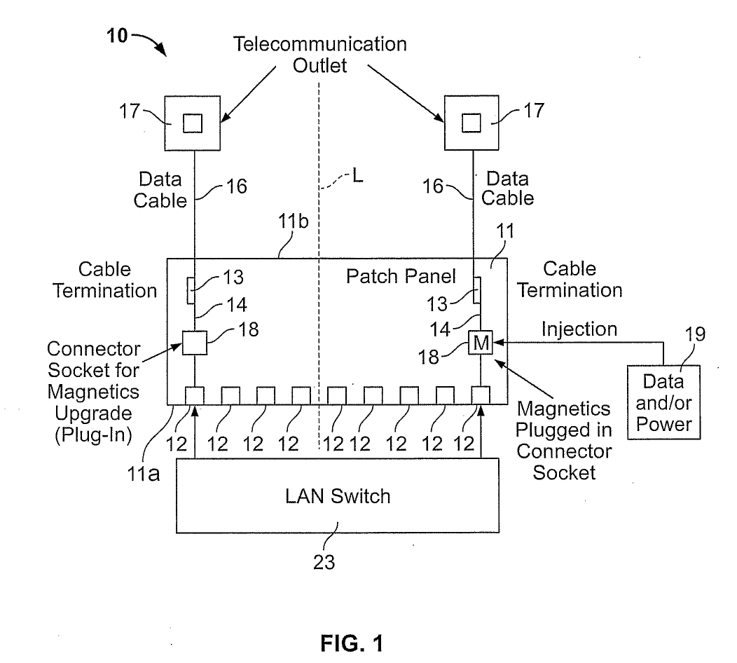

FIG. 1 is a schematic representation of the structure of a patch panel according to the invention;

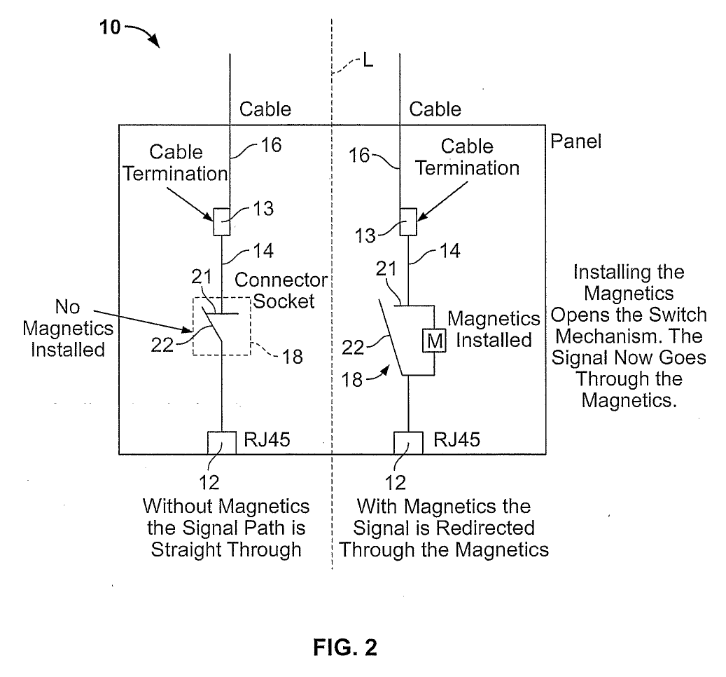

FIG. 2 shows part of the FIG. 1 arrangement in greater detail; and

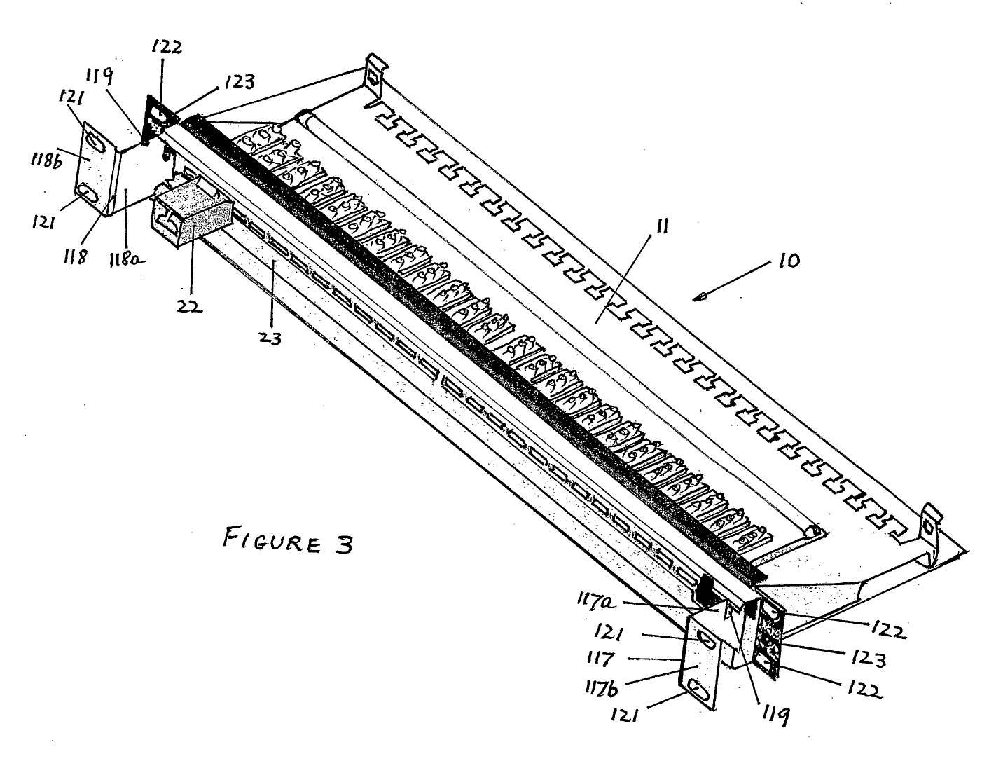

FIG. 3 shows an arrangement of brackets by means of which the patch panel according to the invention may be supported.

Referring to the drawings there is shown in schematic form a network connection device exemplified by a patch panel 10 comprising a support member in the form of a metal or other rigid plate 11.

In a manner known per se in the art of patch panel construction, plate 11 supports on its front edge 11a one or more rows of first sockets 12. A dotted line L in FIG. 1 signifies that the number of such rows, and the number of the first sockets in each row, may be in accordance with the norms in patch panel construction. Thus the layout of the first sockets is not limited to the precise pattern shown.

The first sockets may be, but are not necessarily, of the aforesaid RJ-45 type.

Adjacent the rear face 11b of the plate 11 there is provided a plurality of cable terminations 13 of which two are shown in FIG. 1. In reality there would be provided the same number of terminations 13 as there are first sockets 12 on the front face, such that there is a termination 13 corresponding to each of the sockets 12.

As many of the terminations 13 as are needed in the LAN of which the patch panel 10 forms part are connected to e.g. Category 5 (or other types) of data cable 16 in a manner per se known in the LAN art. The data cables 16 extend e.g. throughout a building and terminate in respective nodes. In the non-limiting example of FIG. 1 the nodes are represented by respective telecommunications sockets 17. However, as is known, the nodes may take any of a range of other forms if desired.

A data transmission line 14 interconnects each termination 13 and its associated socket 12.

A further socket 18 lies in the data transmission line between at least one of the cable terminations 13 and its associated first socket 12. In practice a plurality, and preferably all, the data transmission lines in the patch panel would include a further socket 18 as shown schematically.

The further sockets 18 are each intended to receive a respective plug-in module such as module 19.

In the example shown module 19 is labelled as being able to provide data and/or power and hence is suitable as part of a Power over Ethernet upgrade for the LAN in which the patch panel 10 is connected. Since the components needed to achieve such functionality in a LAN commonly include a number of inductances FIG. 1 refers to the modules generically as “magnetics” M that may be interposed in the transmission paths 14. However as indicated herein any of a range of other types of electronic module, which need not necessarily be or include inductances, may equally easily be interposed in the same manner, using the further sockets 18.

FIG. 2 shows in more detail part of the FIG. 1 apparatus. In particular FIG. 2 shows two of the data transmission lines 14 of FIG. 1.

In FIG. 2 the left hand data transmission line 14 is shown in its condition when no additional component (electronics module 19) is interposed in the line.

As is signified schematically in FIG. 2 the further socket 18 thereof includes a normally-closed switch the contacts 21, 22 of which complete the data transmission line 14 such that data may pass between the first socket 12 and the cable 16 secured operatively in the termination 13.

On installation of an additional component that preferably is in the form of a plug-in module having one or more pins that are insertable into the socket 18, the condition illustrated in the right hand transmission line 14 arises.

In the right hand transmission line 14 a pin of the module has forced the switch terminals 21, 22 apart e.g. against a resilient biasing. The nature of the pin is such that the data transmission path then incorporates the module represented in FIG. 2 by the letter M. Thus the module is able to transmit commands, data and/or power (depending on its precise nature) via the LAN.

In FIG. 2 the connection of the module M is shown schematically, as influencing only a single transmission wire 14. In practice the module M may include a respective pin corresponding to each of the wires of a data cable. The further sockets 18 then would each incorporate a respective switch for each wire of the cable.

Furthermore it is possible for the module M to include a plurality of pins that cause connection of the electronics (“magnetics”) with a plurality of distinct cables. In such a case the module may for example include a sufficient number of appropriately spaced pins to permit their insertion into any number of further sockets 18 in the patch panel 11.

The further sockets 18 are shown in the drawings as lying part way between the cable terminations 13 and the first sockets 12. In this configuration the additional components may be interposed into the data transmission lines 14 e.g. from above the support member 11. In other arrangements of the invention however the further sockets 18 may be located e.g. on the rear face of the support member 11. In all such embodiments it is readily possible also to add to the front of the patch panel yet a further component such as the LAN switch/repeater 23 visible in FIG. 1.

Thus the apparatus of the invention is suited to the addition of electronics components both at the front of the patch panel and elsewhere thereon.

In one arrangement in which one or more modules M are interposed into the data transmission lines 14 the LAN switch 23 may be of a modified kind that with the modules M upgrades the LAN to the Power over Ethernet type.

The electronics components added to the patch panel as described hereinabove may protrude from the patch panel 10, or may prevent the patch panel 10 from fitting within a cabinet or other housing. If the cabinet is fitted with a closeable door or cover this might be inconvenient. Therefore some embodiments of the invention may optionally include brackets, for mounting the support member 11 in a patch cabinet rack in such a way that the member 11 is recessed relative to the position it would normally occupy.

One way of achieving this effect is shown in FIG. 3 in which a largely or entirely conventional patch panel 11 has secured to its in-use front side a LAN switch 23 having the characteristics described herein.

The LAN switch 23 includes a frame in the form of a T-slot channel member 116. This provides a rigid support for the apertures, power bus and other parts of the LAN switch 23. The frame is secured onto the front of the patch panel 11 eg. by means of clips, screws or other fastenings.

The ends of the T-channel section member 116 have received therein respective spacer brackets 117,118. These may on construction of the assembly 10 be slid into the open ends of the channel until eg. a notch 119 engages a co-operating formation in the channel so as rigidly to retain the brackets 117,118 in place each spaced a short distance from an end of the distribution matrix.

Each bracket 117,118 includes a forwardly projecting portion 117a, 118a that terminates in a cranked portion 117b, 118b.

The cranked portions 117b,118b are perforated by pairs of slots 121 that are similar to the slots 122 formed in the conventional securing tabs 123 of the patch panel 11.

The effect of the brackets 117,118 is, when screws or other fasteners are inserted into the slots 121, to permit securing of the assembly 10 in eg. a rack of a per se known patch cabinet. The effect of the brackets 117,118 is to space the patch panel 11 rearwardly in the cabinet compared to where it would lie if secured instead by the conventional tabs 123. This in turn advantageously provides a clearance on the front side of the patch panel 11 to accommodate the LAN switch 23 and any other connected device(s) 22, without these parts of the assembly 10 fouling on a door or cover of the cabinet.

1. A patch panel comprising one or more support members supporting a plurality of cable terminations that are each operatively connectable to a respective data cable for the transmission of data, each cable termination being operatively connected to a respective first socket that is open on a side of the network connection device such that a plug inserted into the first socket is connectable to a said data cable via a data transmission path forming part of the network connection device, the network connection device additionally including in at least a first said data transmission path a further connector that permits the connection in the first data transmission path of one or more additional components.

2. A patch panel according to claim 1, wherein a plurality of data transmission paths in the patch panel each include a further connector.

3. A patch panel according to claim 2, wherein one or more said data transmission paths each include a switch that is operatively connected to the associated further connector.

4. A patch panel according to claim 3, at least one said switch of which is, in the absence of a said additional component, closed such that there is a direct data transmission path between the associated said cable termination and first socket; and is open when a said additional component is connected in the data transmission path such that the transmission of data takes place via the additional component.

5. A patch panel according to claim 1, wherein the further connector includes a second socket.

6. A patch panel according to claim 1, wherein the further connector is located on an in-use rear side of the support member.

7. A patch panel according to claim 1, including one or more said additional components connected in said data transmission path.

8. A patch panel according to claim 7, wherein the additional component is selected from the list including:
a “power over Ethernet” component,
an indicator device.

9. A patch panel according to claim 8, wherein the additional component is a “power over Ethernet” component which includes one or more of:
a power management device,
an inductance,
a combiner,
a filter.

10. A patch panel according to claim 8, wherein the additional component is an indicator device which is capable of providing a visible, audible or other sensory indication of the statuses of the connections of the patch panel.

11. A patch panel according to claim 1, further comprising one or more further, additional components connected via said first socket.

12. A patch panel according to claim 11, wherein the further, additional component includes a LAN switch.

13. A patch panel according to claim 1, including one or more securing brackets secured to the support member.

14. A patch panel according to claim 13, wherein the securing bracket is securable to a rack in a patch cabinet or housing.
